(19) United States
(12) Patent Application Publication
(10) Pub. No.: US 2007/0202884 A1
(43) Pub. Date: Aug. 30, 2007

(54) System, apparatus and method for transmitting event information from a remote terminal to subscribers over a network

(76) Inventors: Katja Nykanen, Helsinki (FI); Ferenc Dosa, Helsinki (FI); Johan Wikman, Helsingfors (FI)

Correspondence Address: MORGAN & FINNEGAN, L.L.P., 3 World Financial Center, New York, NY, 10281-2101, US

(21) Appl. No.: 11/361,200

(22) Filed: Feb. 24, 2006

(51) Int. Cl. H04Q 7/20

(52) U.S. Cl. 455/455

(57) ABSTRACT

A system, apparatus and method for transmitting event information from a remote terminal to subscribers over a network. Remote terminal events, such as a missed call or and SMS messages etc. are routed to a secondary terminal when the subscriber is logged into his or her remote terminal account via a secondary terminal. A subscriber can configure the mobile events for which he or she wants to be notified on a remote terminal. When such an event occurs, and if the subscriber is logged on to his or her remote terminal account, a notifying message is transmitted with some details of the event. The notifying message could be in any one of various unobtrusive forms which minimizes any distraction caused by the message. A subscriber does not have to be in physical possession of his or her remote terminal to be notified of mobile events. Rather, one advantage of the invention is to allow a user to be notified of pre-configured mobile evens in situations where the user has forgotten the remote terminal or spends most of his or her time in front of a computer terminal in a location remote form the remote terminal.

### FIELD OF INVENTION

This invention relates generally to a system, apparatus and method for transmitting event information from a remote terminal to subscribers over a network and, more particularly, to a system, apparatus and method for transmitting event information from a remote terminal over a network to, for example, a user logged into his or her remote terminal account, such transmission being made automatically without the need for the user to make an inquiry to the remote terminal.

### BACKGROUND INFORMATION

Remote terminals, such as mobile phones, are becoming the mainstay of personal communication. In addition to asynchronous voice communication, mobile phones are used for sending messages, such as email, short messages or multimedia messages. Along the same lines, it is also common to use a computer, for example, a desktop, laptop, PDA etc., at work, home or remotely. Digital communication techniques have also fostered the ability to communicate between a remote terminal and a computer, for example, by the use of systems that can synchronize certain events between a host system (i.e. a data computing device) and a mobile phone.

However, such a usage does not take advantage of the asynchronous capabilities of remote terminals. For example, with a mobile phone, a subscriber, such as a user of services like short message service (“SMS”) or multimedia message service (“MMS”) offered by the mobile phone service provider, can receive a call or an SMS or MMS message anytime, asynchronously. Such a user does not have to push buttons to receive an incoming call or SMS. On the other hand, conventional web interfaces do not provide such asynchronous notifications. A user, for example, has to push a button (to “refresh” the screen) each time the user wants to get the latest state.

Some conventional web interfaces do allow automatic refreshing at certain intervals so that a user can get the latest state, however, such systems typically have at least two problems. First, if the refresh interval is small, the interface keeps refreshing itself, thereby flickering while a user is reading the contents. This is very distracting to the user. Second, if the refresh interval is large, the state is not truly asynchronous because a user could be notified of the happening of an event that took place some time back only after a pre-determined time interval. Being notified of a missed call which occurred several minutes ago is not asynchronous communication.

The Gmail™ notifier is a prior art asynchronous email notification application which alerts the user to new messages. The Gmail™ notifier application displays an icon in the user's system tray to inform the user of unread messages, and shows the user the subject, the sender and snippets of the message, all without the user having to open a web browser. However, the Gmail™ notifier is used only with email messages and only by subscribers of Gmail's™ search-based webmail service.

The following example further illustrates the problems and limitations of conventional systems such as the Gmail™ notifier: A remote terminal subscriber, such as a user of a mobile phone, is on her way to work when she notices that she has left her mobile phone at home. She has no immediate information about who is trying to contact her. In fact, the only way she can determine if attempts have been made to contact her is to: (a) wait to return home and check, on her mobile phone, the missed calls log, the voice messages, the SMS etc, or (b) call her voice message retrieval system through an alternate voice communication means such as an office phone, and determine if anyone has left a voice message. Unfortunately, there is no way for the user to access missed calls or text messages or even know if the battery is running low on her mobile phone if the phone is not with her.

Therefore, it would be advantageous if the user could more readily be informed about missed calls or text messages even when she does not have her mobile phone on her person. Accordingly, there may be interest in technologies applicable to notifying a user of such missed calls or text messages etc.

### SUMMARY OF THE INVENTION

According to exemplary embodiments of the present invention, as described below, the problems noted above are overcome by providing a system, apparatus and method for transmitting remote terminal event information between a remote terminal, such as a mobile phone, and one or more subscribers, such as a user of a desktop computer, terminal or other network access device over a network. Such information is transmitted when the user is logged on to his or her remote terminal account over a network. The remote terminal is configured to transmit the information upon the occurrence of the event and without the need for a user to make an inquiry regarding the happening of an event. When information is generated for more than one remote terminal event, a listing of all event information transmitted to a subscriber is generated, and the list presented to a user on his or her network access device.

In one exemplary embodiment, a set of mobile phone events for which a user wishes to be notified is configured and stored on the mobile phone. Upon logging on to his or her mobile phone account through a network access device, such as a desktop computer, interaction between a user's mobile phone and computer begins. This interaction is controlled as a function of the mobile phone event notification configuration and parameters associating a mobile phone to a user. The mobile phone communicates with the desktop computer via a mobile communication system providing the possibility of communicating mobile phone event information to the user.

By way of example, a user may require notification of certain mobile events whether or not a user has access to his or her mobile phone. Based on event notification settings, mobile middleware running on the mobile phone, which, for example, could be specially designed software that allows an application to remotely configure events of interest and receive notifications about such events, automatically notifies a user on his or her desktop computer or other network access device of the happening of an event or a series of events on the user's mobile phone. In this manifestation of the invention the user does not have to make an inquiry to the middleware running on the mobile phone to initiate the transmission of event information.

As another example, based on event notification settings, a user is notified on his or her desktop computer of the happening of an event or a series of events on the user's mobile phone after the desktop computer or other network access device has initiated a request to the mobile middleware running on the mobile phone to transmit event information. In this manifestation of the invention a request to the mobile middleware initiates the transmission of event information to the desktop computer or other network access device.

### BRIEF DESCRIPTION OF THE DRAWINGS

FIG. 1 is an exemplary system diagram showing the transmission of event information from a remote terminal to a subscriber, where the remote terminal event is an incoming SMS message and the subscriber is the user of a desktop computer logged-on to his or her mobile phone account.

FIG. 2 is an exemplary system diagram showing certain details of transmission of event information from a remote terminal to a subscriber, where the subscriber has initiated a request to receive event information and the program module executing the request is running on the subscriber's desktop computer.

FIG. 3 is an exemplary implementation showing certain details of creating a temporary web-server-in-web-browser in one embodiment of transmission of event information from a remote terminal to a subscriber.

FIG. 4 is an exemplary flow chart of one of the possible sequence of steps carried out by the subscriber's desktop computer to interface with the remote terminal (for example, mobile phone) in requesting and receiving event information.

FIG. 5 is a simplified illustration of a remote terminal according to one exemplary embodiment of the present invention showing various components used to perform the procedures of this invention.

It is to be understood that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE INVENTION

The following examples illustrate some of the benefits of the claimed invention in contradistinction to the problems associated with conventional systems as discussed above. As an example, a mobile phone user is on her way to work when she notices that she has left her remote terminal at home. When she reaches her office, she opens her mobile phone website on the computer and logs in. While she is working she receives notifications about arrived SMS's and missed phone calls. If someone important has called her, she can immediately return the call with the office phone.

As another example of the present invention, a mobile phone user is reading his email in an internet coffee shop. His mobile phone is inside his backpack and he does not notice that the battery of his mobile phone is running low. Luckily, he is logged into his mobile phone website and he receives a notification on the computer screen that the battery is running low. He takes the phone out from the backpack and plugs it into the charger.

Other objects and features of the present invention will become apparent from the following detailed description considered in conjunction with the accompanying drawings.

According to exemplary embodiments of the present invention the problems of conventional systems noted above are overcome by providing a system, apparatus and method of interaction for instantaneously transmitting remote terminal event information between a remote terminal, for example a mobile phone, and one or more subscribers, for example a user of a desktop computer or a terminal. The invention as described is not limited to a particular mobile communication system or network, and works with any mobile communication system or network providing the possibility of communicating remote terminal events. As used in this invention, remote terminal events include, but are not limited to, SMS messages, MMS messages, missed calls, and low battery etc.

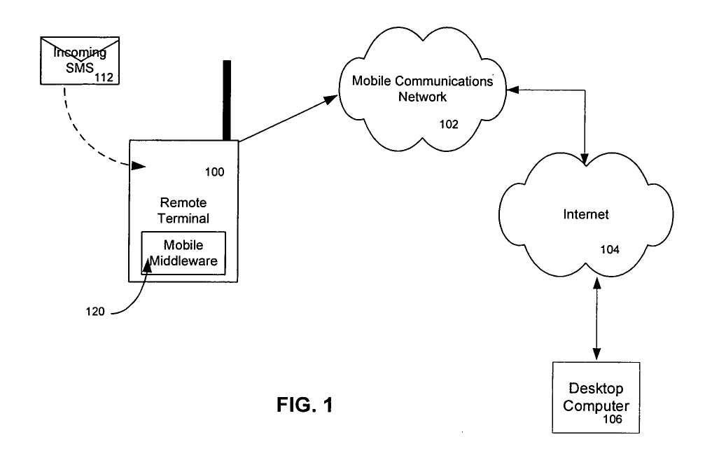

FIG. 1 is an illustrative, non-limiting exemplary embodiment of the present invention showing the system for transmission of event information that enables remote terminals which send and receive event information in accordance with a standard mobile terminal protocol to communicate with an application accessible by a subscriber, such application being implemented in accordance with an Internet protocol, such as the HTTP, Extensible Markup Language (“XML”), or HTML protocol. The event transmission system comprises, for example, a mobile communication network 102 which in this case is the GSM mobile communication network, the remote terminal 100, which in this case is a mobile phone with data messaging capabilities but, alternatively, could be any mobile communicating device operable on any mobile communication system providing the capability of communication of remote terminal events, and at least one subscriber, which in this case is a mobile phone user who has a data computing device, such as a desktop computer 106, terminal or any other network access device.

In FIG. 1, the mobile communication network 102 is connected to the Internet 104 which, for example, is a WAN defined by the use of TCP/IP to exchange information, but which, alternatively could be any other type of WAN. The WAN in turn is connected to a variety of gateways (not shown). A gateway forms a connection or bridge between the WAN and some other type of network, such as an RF wireless network, cellular network, satellite network, or other synchronous or asynchronous land-line connection. The desktop computer 106 can be connected to the landline telecommunication network PSTN by a modem (not shown), to an integrated services digital network (ISDN, not shown) by an ISDN adapter (not shown), or to a Local Area Network (“LAN”), which may also connect to other data computing devices that may be in a user's office or elsewhere.

By way of example, an exemplary general purpose data computing device, such as a desktop computer 106, includes a central processing unit (“CPU”), a system memory, and a system bus that couples various system components including the system memory to the processing unit. The desktop computer 106 further includes a hard disk drive for reading from and writing to a hard disk, a magnetic disk drive for reading from or writing to a removable magnetic disk, and an optical disk drive for reading from or writing to a removable optical disk, such as a CD ROM or other optical media. The drives and the associated computer-readable media provide non-volatile storage of computer readable instructions, data structures, program modules and other data for the desktop computer 106. The desktop computer 106 may operate in a wired or wireless networked environment using logic connections to one or more remote computers. The remote computer may be another personal computer, a server, a router, a network PC, a peer device or other network node, and typically includes many or all of the elements described above relative to the desktop computer 106.

In the illustrative, non-limiting exemplary embodiment of the present invention, an SMS Message 112 in FIG. 1 represents an external text message from a sender sent to a subscriber's remote terminal 100. By way of example, the SMS protocol allows a user to send and receive short alphanumeric messages (typically up to 160 characters) via his or her mobile telephone. Such a protocol can be used in GSM, Time Division Multiple Access (“TDMA”) and Code Division Multiple Access (“CDMA”) communication systems. The SMS protocol allows a user to connect to a mobile communication network on a “message-by-message” basis. For example, if a user sends an SMS message to a mobile communication network, a connection between the user's mobile phone and the network is established, the SMS message is sent to the network, and the connection is terminated. In FIG. 1, the SMS Message 112 could be sent from another user's remote terminal (not shown), or any user connected to the Internet (not shown), or by any other means of sending a SMS message.

In FIG. 1, the SMS message 112 is received by the remote terminal 100. Based on rules configured on the remote terminal, a program module determines whether a subscriber needs to be notified about the received SMS message 112. The remote terminal 100 is running mobile middleware 120, which determines the destination of the SMS information. By way of example, the mobile middleware 120 could be specially designed software that allows a mobile phone application to configure events of interest and subsequently be notified of the occurrence of a configured event. The mobile middleware 120 then transmits the event information to the subscriber, provided that the subscriber is logged-on to his or her remote terminal account via the desktop computer 106. The information may be transmitted, for example, as a message according to a TCP or UDP protocol, a delayed HTTP response to a polling HTTP request from the desktop computer 106, or an HTTP request over the mobile network 102 to the subscriber program on desktop computer 106 via the Internet 104. In the exemplary embodiment shown in FIG. 1, an HTTP request is transmitted over the mobile network 102 to the subscriber program on desktop computer 106 via the Internet 104 and a program module on the Internet 104 routes the HTTP request to a program on desktop computer 106 that is capable of receiving HTTP requests. The subscriber program on the desktop computer 106 formats the information received in a viewable format for the subscriber who can then view it on his or her computer screen.

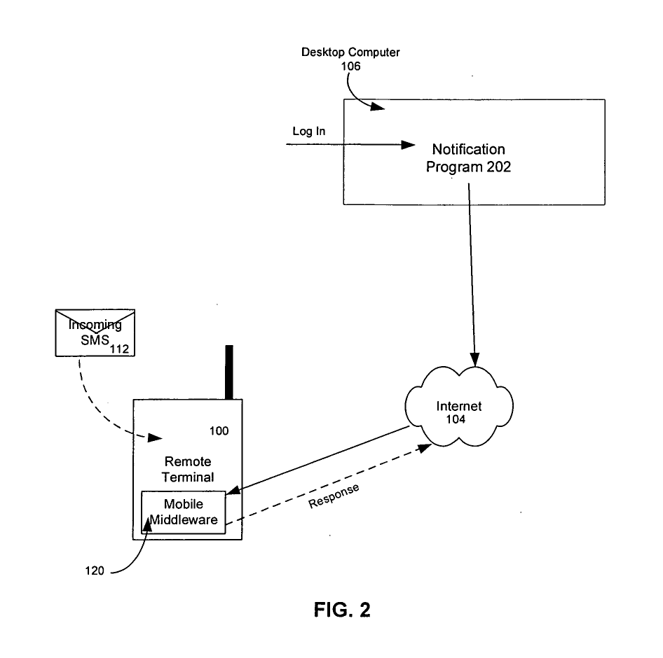

Referring to FIG. 2, a subscriber logs on to his or her desktop computer 106 and activates the application on the desktop computer 106 to communicate with the mobile middleware 120. By way of example, the desktop computer 106 includes, along with the typical hardware and software associated with a desktop computer, the notification program 202 which is executed once a user is logged on. Once executed, the notification program 202 opens a connection to allow the mobile middleware 120 to send notifications related to mobile events configured for notification on the mobile phone 100 asynchronously, from the mobile phone 100 to the notification program 202. The notification program 202 communicates with the mobile phone 100 by outputting the notifications to the subscriber. The mobile middleware 120 generates a HTTP response to the HTTP request. In the exemplary embodiment shown in FIG. 2, the SMS message 112 is sent over the mobile network 102 and the Internet 104 to the desktop computer 106 and is displayed to a subscriber. Once the event information is received by desktop computer 106 and is parsed for display the notification program 202 continues to keep the connection open in order to receive new notifications from the mobile middleware 120.

Various technologies may be used within the mobile middleware 120 and the notification program 202 to allow for transmitting notifications asynchronously from the mobile middleware 120 to the notification program 202. By way of example, the notification program 202 can be a webpage shown in a browser using JavaScript and Asynchronous JavaScript Technology and XML (“AJAX”) web technology. Once a subscriber is logged on to, e.g., a desktop computer 106 he or she logs onto his or her mobile phone account. Then the initial loading of the interface for the web application “/pcconsole” is completed, provided that, for example, the mobile middleware 120 on the mobile phone includes a web server that can respond to an HTTP request and that the web application related to the notification program 202 is prepared for execution and is accessible at URI “/pcconsole” for downloading to the web browser. Next, after necessary objects such as images, CSS, and JavaScript etc. are loaded the notification JavaScript in the notification program 202 (in this exemplary embodiment the webpage downloaded to the context of a web browser) is displayed and starts execution, polling the mobile phone 100 to fetch XML documents containing data to be parsed. Under the AJAX JavaScript programming paradigm, an XmlHTTPRequest object makes a new HTTP request to “poll” the status of the mobile phone 100 to Uniform Resource Identifier (“URI”) “/pcconsole/events?observer=username”. The URI “/pcconsole/events?observer=katja” is one example that the application “/pcconsole” will accept HTTP requests, provided the user is identifiable, in this example as “katja.” Once a user has been authenticated, the mobile middleware will return a response of the HTTP request in the form of XML documents. In this exemplary embodiment, AJAX (and XmlHTTPRequest object) is executing asynchronously, therefore, when the response is received, then the XML response body is parsed by the web application. The handler functions, which in this case are references to JavaScript functions that receive and deal with the event when it occurs, are initialized. Once initialized, these functions allow the webpage (“PcConsole”) to continue interaction with a user, and whenever an XML response is received it is handled by the appropriate function programmed in the web application.

In the exemplary embodiment shown in FIG. 2, there are several ways in which the HTTP requests can be answered by the mobile phone 100. As an example, the HTTP request may not be answered until an event occurs on the mobile phone 100 that is configured to produce a notification to a user. Once the event happens on the mobile phone 100, the mobile middleware 120 responds to the HTTP request sending an XML response which in this example would be:

HTTP/1.1 200 OK
<event>

<sms>

<sender>Tero</sender>
<msg>I'll be 10 min late</msg>

</sms>

</event>

The XML response is received by the web application on the desktop computer 106 and is parsed for display as a notification to the user. In this example, the HTTP request is pending all the time and therefore, may autonomously time out just like the browser which initiates the request, unless an event worth notification is received on the mobile phone 100 and dispatched by the mobile middleware 120 to the notification program 202 (in this example the AJAX web application) by means of an HTTP response to the HTTP request still pending.

As another example, the HTTP request may be answered by the mobile middleware 120 at one minute intervals even if no event has occurred and consequently there is nothing to send back. Once the HTTP response is received by the web application on the desktop computer 106, which in this example would be blank, a new request is made immediately. In this example, the implementation is such that an application level “push” is implemented at the lower level as a regular “pull,” a situation similar to the conventional page refresh mechanism on a web browser. However, in this example, the browser screen does not flicker, and the interaction is still smooth because the web page itself is not reloaded or re-rendered.

As yet another example, the HTTP request is answered immediately by the mobile middleware 120 using chunked encoded XML elements. An HTTP response can indicate that it is returning a chunked response, in which case it returns the data as a series of length-prefixed chunks, as “chunked transfer encoding” as defined in the HTTP 1.1 standard. In this example, most of the time the chunked response will be empty and therefore convey no notification. Whenever a remote terminal event occurs the chunked response from the mobile middleware 120 will contain data that is received by the program module on desktop computer 106 and is parsed for display as a notification to the user.

As another example of one exemplary embodiment of the present invention, the notification program 202 is an application specific Java Applet which acts as a temporary web server on the desktop computer 106 in the context of a Java enabled web browser—an embodiment that is atypical to the common use of Java Applets which, when involved in any form of communication, are normally used as web clients. Such a temporary web server, as described herein and as used in this example, creates a notification dialog when it receives from the mobile middleware 120 an HTTP request with details about a remote terminal event. In this example, the notification program 202 does not have to send an HTTP request. It is the mobile middleware 120 that acts as an HTTP client to the notification program 202 (in this example the Java Applet temporary web server) and is executed in the context of the web browser. The mobile middleware 120 transmits information to the user on the happening of a mobile phone event thereby achieving event notification in an asynchronous manner. In this example, the temporary web server on the desktop computer 106 can display a pop-up notification displaying “You have a message” when it receives XML data from the mobile middleware 120 telling it that a new mobile phone event has occurred. The XML data in this example would be:

PUT /mobileobserver HTTP/1.1
<event>

<sms>

<sender>Tero</sender>
<msg>I'll be 10 min late</msg>

</sms>

</event>

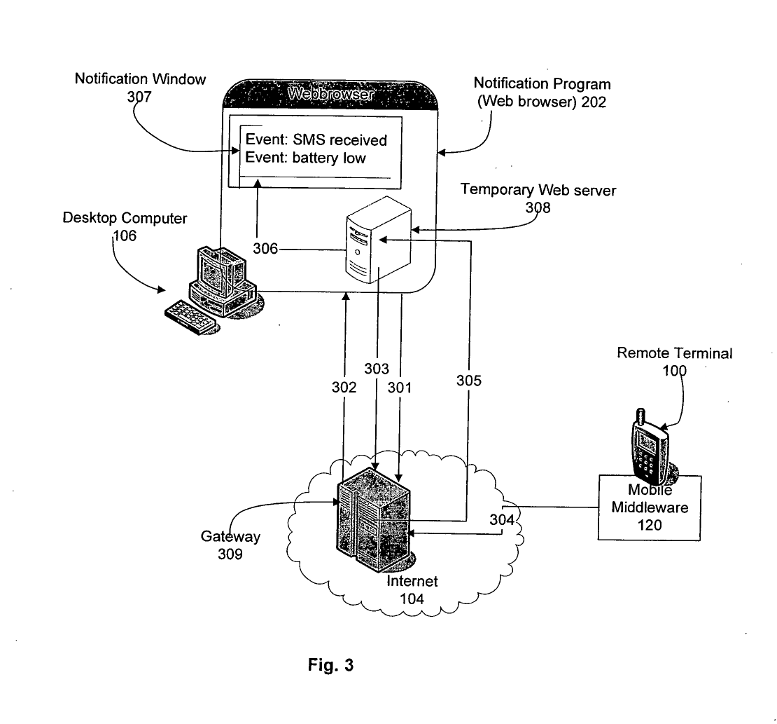

FIG. 3. illustrates the temporary web-server-in-web-browser in the context of an exemplary embodiment where the notification program is a Java Applet maintaining a connection to the reverse HTTP proxy according to a proprietary protocol and a conceptual temporary web server. First an HTTP request is made from the web browser to the web server (301). Once the request is received, the web server sends an HTTP response (302), which for example could be in the format:

<html>

<head><title>Temporary web server in web browser
</title></head>
<body>

<applet code=“...”

archive=“tmpwebserver.jar”
<param .../>

</applet>

</body>

</html>

The web browser determines the URL it has to download the Java Applet file from, which by way of example may be http://www.wswb.com/tempwebsrv/tmpwebsrvjar, and downloads it from the web server. After downloading, the Java Applet is initialized with configured parameters (as may be required) and is executed. This Java Applet (i.e. the temporary web server (308) applet), will make a connection (303) back to the web server to some specified port, and wait for HTTP requests to come. This connection is opened from the Java Applet (executing in the context of the web browser) to the web server, and not the other way around, as it would be customary if the web server was merely a pure (reverse) HTTP proxy. This special connection must be capable of conveying HTTP messages (requests and replies).

After the connection is initiated, the web server acts as a reverse HTTP proxy, e.g. by mapping the temporary web server onto its own URL space with a URL address, for example, http://www.wswb.com/˜katja. The mobile middleware acting as an HTTP client to the notification program transmits information to the user on the happening of a mobile phone event (304). The gateway (309) determines which connection should be used to dispatch the notification, as there may be a plurality of temporary web servers connected at any give point in time. The web server routes the notification information to the notification program (305), or more precisely, to the temporary web server (308) which, in turn, dispatches the information to the notification program (202), particularly, in this example, the user interface (i.e. notification window (307)) part of the notification program (202), which then receives the information and parses it for display as described above.

In the examples implementing a Java Applet which acts as a temporary web server on the desktop computer 106 in the context of a Java enabled web browser, the web browser on desktop computer 106 must be addressable. In a conventional system applying this example, the web browser on the desktop computer 106 is not addressable because the Java Applet, for security reasons, cannot create server sockets and cannot make connections to a web site other than the web server where it was downloaded. The addressability of the notification program 202 (in this example a Java Applet running in the context of a web browser) can be solved, for example, by introducing a custom internet gateway (309) that acts as a reverse HTTP proxy to all such temporary web-server-in-web-browser notification programs 202 by assigning them temporary URLs via which they can be accessed. In the present exemplary embodiment an example of the temporary URL would be http://www.wswb.com/˜katja. The connection between such reverse HTTP proxy i.e. gateway (309) and the Java Applet notification program 202 must be maintained so that all HTTP requests arriving at URL http://www.wswb.com/˜katja can immediately be dispatched through the said connection to be processed by the notification program 202. The connection between the reverse HTTP proxy and the Java Applet can be implemented in many ways. For example, the connection could be a proprietary TCP protocol, or it could be implemented in terms of an HTTP protocol with mechanisms to provide asynchronicity similar to an AJAX implementation i.e. a conceptual push can be implemented in terms of HTTP requests that are stalled until there is an event notification message to send, or HTTP requests stalled for only a certain short period (e.g. 1 minute) and answered whether there is something to report or not, or HTTP requests continuously answered by a stream of HTTP chunks that most of the time convey no payload notification. Having conceptually an invocable web server in the context of the web browser on the desktop computer 106 enables the mobile phone to send an HTTP message to the web browser telling it about a new event right after the event occurs, or at anytime thereafter.

The addressability of the notification program 202 is resolved because the Java Applets are allowed to open connections to any port and use any protocol (e.g. connection DB) to connect to their origin server, in this case the gateway (309). Gateway (309), in turn, presents the connected Java Applet as a web content provider mapped into its own temporary URL space (i.e. the originating web server acts as a reverse HTTP proxy). This will, in effect, mean that a special purpose temporary web server is implemented in the context of the Java enabled web browser on the network device.

It should be noted that the exemplary embodiments involving the AJAX solution (i.e. when the mobile middleware 120 includes a web server and notification program 202 is an AJAX page executed in the context of the web browser) and the solution with the reverse HTTP proxy (i.e. where the notification program 202 is a Java Applet maintaining a connection to the reverse HTTP proxy according to a proprietary protocol and a conceptual temporary web server) both maintain a constant connection. In the case of the AJAX solution the connection can be only HTTP based while in the reverse HTTP proxy case the connection can be a TCP protocol also. However, in the reverse HTTP proxy i.e. gateway (309) case the notification program 202 does not maintain the connection to the mobile web server included in the mobile middleware 120, but it maintains the connection to the reverse HTTP proxy i.e. gateway (309) on the Internet 104. This means reduced cost in terms of traffic and battery usage. Another advantage of reverse HTTP proxy is that it hides the technical details of connection maintenance from the application programmer and presents the application programmer writing the notification program 202 a clean and well understood paradigm to create the notification displayer notification program 202.

It is to be noted that these exemplary embodiments may be implemented in a cellular context i.e. such that the desktop computer 106 is a network device, which for example could be another remote terminal i.e. a second mobile phone or any mobile communicating device operable on any mobile communication system, and the notification program 202 is executed on the network device. In such an exemplary embodiment, the subscriber will log into his or her second mobile phone account via an interface on the second mobile phone, and as discussed in exemplary embodiments above, various technologies used within the mobile middleware 120 and the notification program 202 allow for transmitting notifications asynchronously from the mobile middleware 120 to the notification program 202 and to the subscriber on his or her second mobile phone.

It is to be noted that while the exemplary embodiment of the reverse HTTP proxy refers to the notification program 202 as being written as a Java Applet, it is by no means restricted to Java technology and can be implemented, for example, as a JavaScript, or any other technology that allows dynamically downloaded programs to execute in the context of a web browser and can create socket connections and/or HTTP requests to the originating server it was downloaded from, e.g. Macromedia Flash™.

In yet another example where the mobile phone is using Bluetooth or WLAN technology a small reverse HTTP proxy with stripped down functionality (not shown) can be installed on the mobile phone 100 or on Desktop Computer 106 which will then act as a gateway similar to the one in a cellular context utilizing a reverse HTTP proxy in the mobile communication network 102. This example is particularly important in implementing the present invention for the conventional Bluetooth system, where there is no gateway in the mobile communication network 102, because the task of keeping the connections with the mobile phone alive is entirely the task of the gateway connection protocol, which for example may use different keepalive, streaming, polling, pushing mechanisms or any combination thereof.

In one exemplary embodiment of the present invention, customized software is developed to be used as notification program 202, which allows the desktop computer 106 to receive asynchronous notifications from the mobile middleware 120 via Bluetooth/WLAN. A user executes the notification program 202 which, when executed receives one or more asynchronous notifications from the mobile middleware 120, parses those notifications and displays them to the user.

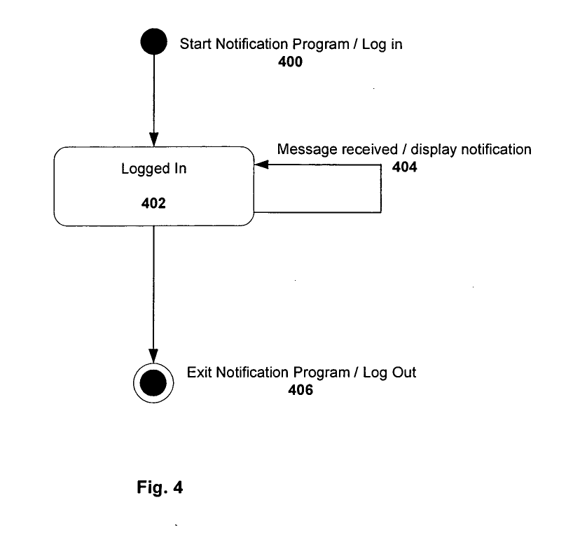

FIG. 4 shows an illustrative, non-limiting state chart of the steps carried out in one exemplary embodiment of the present invention. Upon startup in step 400, the notification program 202 establishes connection to the mobile middleware 120, logging in the user to his or her account. Next, the notification program 202 is in a logged-in state 402, ready to receive messages over the connection established with the mobile middleware 120. In step 404, upon receiving a message notification program 202 parses its contents and displays to the user all notifications that may have been part of the message payload. Finally, the notification program 202 returns to state 402, ready to receive further messages from middleware 120. The event of shutting down notification program 202 is shown in step 406, where the notification program 202 logs out from the mobile phone account and closes the connection to the middleware, after which no further messages will be sent to notification program 202.

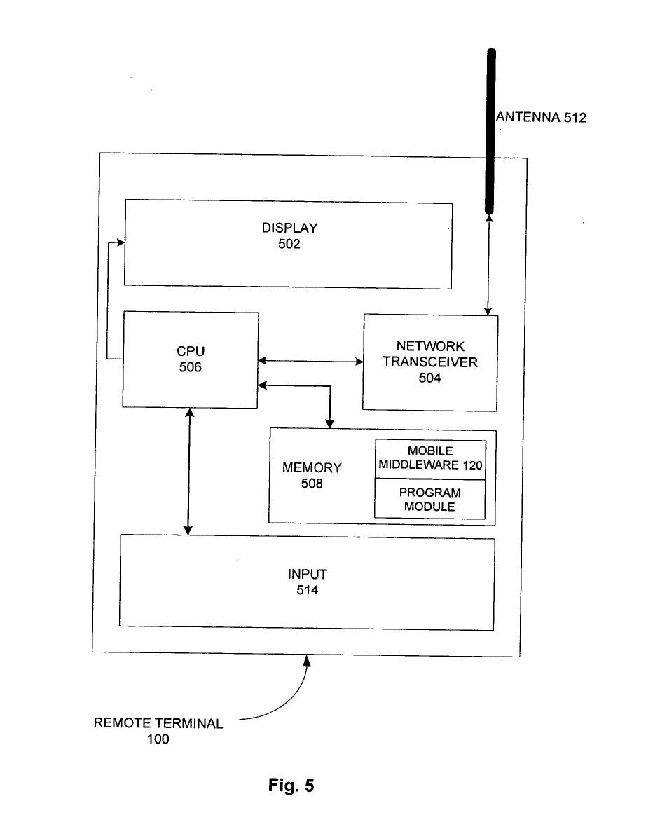

FIG. 5 is a simplified illustration of remote terminal 100 according to one exemplary embodiment of the present invention showing various components used to perform the procedures of this invention. Remote terminal 100, for example, comprises a display 502 that allows the user to, for example, read information related to configuring a remote terminal event. The remote terminal 100 further comprises a network transceiver 504 to receive requests from and/or transmit responses to the mobile communication network 102, a central processing unit (CPU) 506 for controlling and executing all necessary procedures and a memory 508. Remote terminal 100 also comprises an antenna 512, and one or more inputs 514 for inputting the information into the remote terminal. Input 514 may be, for example, a numeric keypad, a keyboard, a software keyboard touch screen, a touch screen (in combination with the display 502), a mouse, a pointing device such as pointing pen, etc.

Mobile middleware 120 residing in memory 508 of remote terminal 100 could be specially designed software that allows a mobile phone application to configure events of interest and subsequently be notified of the occurrence of a configured event. Mobile middleware 120, or other program modules residing in memory 508, can also be used to associate a remote terminal with a particular user, to determine if the user is logged on, and to generate and send notifying messages on the happening of a configured mobile phone event.

It is noted that these examples are not intended to limit the breadth and scope of the invention, but rather to illustrate the variety of possibilities embodied in the transmission of remote terminal event information to subscribers over a network.

Hardware and Software

Various operations and/or the like described hereinabove may, in various exemplary embodiments, be executed by and/or with the help of computers. Further, for example, devices described hereinabove may be and/or may incorporate computers. The phrases “data computing device,” “general purpose computer,” “computer,” “remote terminal,” and the like, as used herein, refer but are not limited to a smart card, a media device, a personal computer, an engineering workstation, a PC, a Macintosh, a PDA, a portable computer, a computerized watch, a wired or wireless terminal, phone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

The phrases “data computing device,” “general purpose computer,” “computer,” “remote terminal,” and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Each of I/O interfaces may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee, Bluetooth, Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage may be a hard drive, optical drive, a memory chip, or the like. Processors may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, or an IBM, Toshiba, or Sony Cell processor. Computer as shown in this example also includes a touch screen and a keyboard. In various exemplary embodiments, a mouse, keypad, and/or interface might alternately or additionally be employed. Computer may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various exemplary embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various exemplary embodiments, peer-to-peer and/or grid computing techniques may be employed. It is additionally noted that, in various exemplary embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

It is noted that various operations and/or the like described herein may, in various exemplary embodiments, be implemented in hardware (e.g., via one or more integrated circuits). For instance, in various exemplary embodiments various operations and/or the like described herein may be performed by specialized hardware, and/or otherwise not by one or more general purpose processors. One or more chips and/or chipsets might, in various exemplary embodiments, be employed. In various exemplary embodiments, one or more Application-Specific Integrated Circuits (ASICs) may be employed.

The present invention is described above by using the Global System for Mobile Communication (“GSM”) mobile communication system as an example of the information transmission network system. However, the invention is not limited to this mobile communication system. The invention can also be applied in other mobile communication systems which have the capability for transmitting addressed information. The mobile communication system can be simplex or duplex.

As is known, a GSM mobile communication network consists of mobile services switching centers (“MSC”) and of base station systems (“BSS”). A base station system consists of a base station and a base station controller. Each BSS is controlled by one MSC. MSC's communicate with each other, wherein calls and other signaling can be transmitted within the mobile communication network as well as between the mobile communication network and a landline telecommunication network or another mobile communication network. In the same geographical area, there can also be several mobile communication networks. The MSC has a home location register (“HLR”) and a visitor location register (“VLR”). The HLR is a database of the mobile communication network containing the basic data of the mobile phone subscribers registered in the network. The HLR contains, for example, the international mobile subscriber identity, the mobile subscriber international ISDN number, and data related to the services available to the subscriber. The VLR is a database of the mobile communication network containing the data required of the mobile subscribers within the area of the mobile communication network at each time for the transmission of calls. The visitor location register VLR is used, for example, for the control of the mobility of the mobile phone, wherein calls and messages can be directed to the correct mobile phone, also in a situation where the mobile phone is in the area of a different mobile communication network than in which the mobile phone is registered. This situation comes also for example when the mobile phone is used abroad.

With GSM mobile phones, each mobile subscriber must have at least one subscriber identity module (“SIM”) card. This SIM card contains the identification data of the mobile subscriber, such as the code and telephone number of the mobile subscriber. Thus by using these identification data, the messages and calls can be directed to the correct mobile station. The SIM card can also be moved to another mobile station, if necessary, wherein also the calls are transmitted to this other mobile phone. The use of a SIM card requires usually that a PIN code is entered at the stage when the mobile phone is turned on. This PIN code can be changed by the mobile subscriber, and the code is intended for preventing misuse of the SIM card for example if the SIM card is lost.

Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the exemplary embodiments, features, methods, systems, and details of the invention that are described above in the application may be combined separately or in any combination to create or describe new exemplary embodiments of the invention.

It is noted that the various examples of this exemplary embodiment are not intended to limit the breadth and scope of the invention, but rather to illustrate the variety of possibilities embodied in processing and displaying the notification of remote terminal events to a user.

What is claimed is:

1. A method for transmitting information over a network, comprising:
operating mobile middleware on a remote terminal;
associating said remote terminal to a subscriber; and
communicating remote terminal event information to the subscriber over a mobile communication network.

2. The method of claim 1, wherein said remote terminal is a cellular telephone, a satellite telephone, a personal digital assistant, a bluetooth device or any other such similar device.

3. The method of claim 1, wherein said mobile middleware may be accessed through an interface on the remote terminal or through a secondary terminal, said secondary terminal being connected to the remote terminal through at least one network.

4. The method of claim 1, further comprising transmitting information within a peer-to-peer network or any data communication network capable of transmitting and receiving data from a remote terminal to a secondary terminal.

5. The method of claim 1, further comprising transmitting event information asynchronously, wherein said information is transmitted when a remote terminal event occurs, at pre-determined time intervals, continuously or in any other manner which can achieve asynchronous transmission.

6. The method of claim 1, wherein transmitting information may involve consultation of one or more rules residing on the mobile middleware or on a secondary terminal.

7. The method of claim 1, wherein the mobile middleware executes a program module that initiates the transmission of event information.

8. The method of claim 7, wherein the initiation of the transmission of information may be in response to a request generated by a secondary terminal.

9. The method of claim 1, wherein the transmitted information is a notifying message corresponding to a missed call, a short message service message, a text message, a multimedia message, a low battery indication, a no signal indication, a contact directory entry, a devicebook entry, an image, a picture, a video clip, an audio clip, an animation, instant message, a chat application, an email or any other event that is customarily associated with a remote terminal.

10. The method of claim 1, wherein information transmitted from the remote terminal may or may not contain data.

11. The method of claim 1, wherein information is transmitted to a subscriber only if the remote terminal is powered on and the subscriber is logged on to his or her remote terminal account through a secondary terminal.

12. A method for subscribing to information, comprising:
associating a subscriber to a remote terminal;
selecting at least one remote terminal event for which information is to be received;
receiving said information over a mobile communication network; and
processing and displaying the information on a secondary terminal.

13. The method of claim 12, further comprising receiving information from the mobile middleware operating on a remote terminal within a peer-to-peer network or any data communication network capable of transmitting and receiving data from a remote terminal to a secondary terminal.

14. The method of claim 12, wherein said secondary terminal may be connected to at least one computer either directly or over a network and said secondary terminal further comprising:
a memory having program modules stored therein; and
a processor disposed in communication with the memory for carrying out instructions in accordance with the stored program modules, wherein the processor and stored program modules are configured to:
associate a subscriber to a remote terminal;
receive information over a mobile communication network; and
process and display information on a user interface.

15. The method of claim 12, wherein said subscribed events occur on a remote terminal.

16. The method of claim 12, further comprising receiving event information asynchronously, wherein said information is received when a remote terminal event occurs, at pre-determined time intervals, continuously or in any other manner which can achieve asynchronous reception.

17. The method of claim 12, wherein said information may be received in response to a request generated by the secondary terminal.

18. The method of claim 12, wherein receiving said information or generating requests to receive said information may involve consultation of one or more rules residing on the mobile middleware or on the secondary terminal.

19. The method of claim 12, wherein the secondary terminal executes a program module to receive the information.

20. The method of claim 12, wherein the transmitted information is a notifying message corresponding to a missed call, a short message service message, a text message, a multimedia message, a low battery indication, a no signal indication, a contact directory entry, a devicebook entry, an image, a picture, a video clip, an audio clip, an animation, instant message, a chat application, an email or any other event that is customarily associated with a remote terminal.

21. The method of claim 12, wherein information received from the remote terminal may or may not contain data.

22. The method of claim 12, wherein information is received by a subscriber only if the remote terminal is powered on and the subscriber is logged on to his or her remote terminal account through a secondary terminal.

23. A system for transmitting information, comprising:
a remote terminal configured to correlate a remote terminal with a remote terminal event, to correlate a remote terminal to a subscriber and to transmit event information;
a mobile communication network; and
a secondary terminal configured to associate a subscriber to a remote terminal, to receive remote terminal event information and to process and display information on a user interface.

24. The system of claim 23, wherein said subscriber accesses an interface on said secondary terminal which is connected to at least one computer either directly or over a network, said secondary terminal further comprising:
a memory having program modules stored therein; and
a processor disposed in communication with the memory for carrying out instructions in accordance with the stored program modules, wherein the processor and stored program modules are configured to:
associate a subscriber to a remote terminal;
receive information over a mobile communication network; and
process and display information on a user interface.

25. The system of claim 24, wherein the processor dispatches a request within a peer-to-peer network or any data communication network capable of transmitting and receiving data from a remote terminal to a secondary terminal.

26. The system of claim 24, wherein the interface on said secondary terminal is a temporary web-server-in-web-browser, wherein the web browser is addressable and capable of supporting the execution of downloaded functionality, and the temporary web server is implemented in the context of the web browser, is invocable, and is implemented using web technology that can create connections to the web server.

27. The system of claim 23, wherein event information is transmitted or received only if said remote terminal is powered on and said subscriber is logged on to his or her remote terminal account through a secondary terminal.

28. The system of claim 23, wherein the transmitted information is a notifying message corresponding to a missed call, a short message service message, a text message, a multimedia message, a low battery indication, a no signal indication, a contact directory entry, a devicebook entry, an image, a picture, a video clip, an audio clip, an animation, instant message, a chat application, an email or any other event that is customarily associated with a remote terminal.

29. A temporary web-server-in-web-browser, comprising:
a web browser, wherein the web browser is addressable and capable of supporting the execution of downloaded functionality;
a web server; and
a gateway,
wherein the temporary web server is implemented in the context of a web browser, is invocable, and is implemented using web technology that can create connections to the web server.

30. The temporary web-server-in-web-browser according to claim 29, wherein in the cellular context the temporary web-server-in-web-browser is made addressable by using a mobile gateway, and wherein in the wireless context the temporary web-server-in-web-browser is made addressable by installing a gateway on the remote terminal.

31. An article of manufacture comprising a computer readable medium containing program code that when executed causes a remote terminal to perform:
reading information regarding a remote terminal event;
determining whether information regarding the event is to be transmitted to at least one subscriber;
operating the mobile middleware; and
communicating with said mobile middleware to transmit information regarding said remote terminal event.

32. An article of manufacture comprising a computer readable medium containing program code that when executed causes the mobile middleware to perform:
associating said remote terminal to at least one subscriber;
communicating with said remote terminal and secondary terminal over a network; and
transmitting event information over said network.

33. The article of manufacture of claim 32, wherein transmission of event information may be in response to a request generated by a secondary terminal.

34. An article of manufacture comprising a computer readable medium containing program code that when executed causes a secondary terminal to perform:
receiving event information; and
processing and displaying received information to said subscriber on a user interface.

35. The article of manufacture of claim 34, wherein receiving event information may be in response to a request generated by a secondary terminal.

36. The article of manufacture of claim 34, wherein processing and displaying received information to said subscriber may be on a user interface which is a temporary web-server-in-web-browser, wherein the web browser is addressable and is capable of supporting the execution of downloaded functionality, and wherein the temporary web server is implemented in the context of the web browser, is invocable, and is implemented using web technology that can create connections to the web server.

37. An apparatus for transmitting event information over a mobile communication network, comprising:
a network transceiver for receiving from, and transmitting to, a network;
an input mechanism capable of configuring the transmission of event information;
a memory having event information, subscriber information, and program modules stored therein, said program modules containing mobile middleware; and
a processor disposed in communication with the memory for carrying out instructions in accordance with the stored program modules, wherein the processor and stored program modules are configured to:
associate a remote terminal to a subscriber; and
communicate information regarding a remote terminal event to a subscriber over a mobile communication network.

38. The apparatus of claim 37, wherein the transmitted information is a notifying message corresponding to a missed call, a short message service message, a text message, a multimedia message, a low battery indication, a no signal indication, a contact directory entry, a devicebook entry, an image, a picture, a video clip, an audio clip, an animation, instant message, a chat application, an email or any other event that is customarily associated with a remote terminal.

39. The apparatus of claim 37, wherein event information is transmitted to a subscriber only if the remote terminal is powered on and the subscriber is logged on to his or her remote terminal account through a secondary terminal.

40. The apparatus of claim 37, wherein transmission of event information may be in response to a request generated by a secondary terminal.

41. The apparatus of claim 37, wherein said mobile middleware contained in program modules stored in the memory may be accessed through an interface on the remote terminal or through a secondary terminal, said secondary terminal being connected to at least one computer either directly or over a network.

42. The apparatus of claim 37, wherein said mobile middleware contained in program modules stored in the memory, in the cellular context, is made addressable by using a mobile gateway.

43. The apparatus of claim 37, wherein said mobile middleware contained in program modules stored in the memory, in the wireless context, is made addressable by installing a gateway on the remote terminal.
